(19) United States
(12) Patent Application Publication
(10) Pub. No.: US 2010/0148460 A1
(43) Pub. Date: Jun. 17, 2010

(54) CONVERTIBLE MULTIMODAL CHILD VEHICLE

(75) Inventors: Royce Nelson, Oakland, CA (US); Phillip H. Neal, San Rafael, CA (US)

Correspondence Address: PATENT LAW OFFICES OF MICHAEL E. WOODS, 16 Hazel Ct., San Rafael, CA, 94901-5223, US

(73) Assignee: Diggin Active, Inc., Emeryville, CA (US)

(21) Appl. No.: 12/333,246

(22) Filed: Dec. 11, 2008

(51) Int. Cl. B62K 9/00

(52) U.S. Cl. 280/87.021

(57) ABSTRACT

A convertible multimodal vehicle (e.g., balance bike and kick scooter) particularly suited for small children. A representative vehicle convertible between a balance bicycle and a scooter, the vehicle includes (a) a platform for supporting a rider standing on the platform, the platform having at least one standing portion generally close to and parallel to a surface supporting a movement of the vehicle over the surface; (b) a steering arrangement coupled to a forward portion of the platform, the steering arrangement enabling the rider to control a direction of the movement of the vehicle; (c) a motive system, coupled to the platform, consisting of a pair of wheels, a forward wheel coupled to the steering arrangement and a rear wheel coupled to a rear portion of the platform; and (d) a seating arrangement, remove ably coupled to the platform, for supporting the rider when seated on the seating arrangement, the seating arrangement providing a scooter-mode when removed and a balance-bicycle mode when installed; wherein the rider propels the movement in both modes using at least one foot to periodically contact the surface and wherein the vehicle does not include an alternate propulsion system selected from the group consisting of one or more of a motor, a pedal-system, a towing system, and combinations thereof.

### BACKGROUND OF THE INVENTION

The present invention relates generally to amusement devices, and more particularly to multimodal self-propelled two-wheeled vehicles for young children.

There are many types of convertible multimode vehicles including vehicles convertible between a bicycle mode and a scooter mode. A particular focus of this invention is use of a balance bicycle mode in contrast to standard bicycle mode of other convertible systems.

A balance bicycle (also sometime referred to as a balance bike or a run bike) is a training bicycle that helps the rider learn balance and steering. It has no pedals, no crankset and chain, and no training wheels. It can be a normal bicycle with pedals and related parts removed, or it can be purpose-built (especially for very small children, for whom normal bicycles are generally not available). It can have no brake, or it can have one or two hand-activated rim brakes.

To function properly, a balance bicycle must be small enough that the rider can walk the bicycle while sitting comfortably in the saddle, putting both feet flat on the ground. The rider first walks the bicycle while standing over the saddle, then while sitting in the saddle. Eventually, the rider feels comfortable enough to run and “scoot” while riding the bicycle, then to lift both feet off the ground and cruise while balancing on the two wheels.

Some people believe that children as young as about eighteen months are able to learn to cruise a balance bicycle within a few hours' practice. With a balance bicycle, the rider learns balance first, pedal last. In contrast, with a normal bicycle fitted with training wheels, the rider learns pedal first, balance last. Although opinions differ regarding which learning sequence is easier for most riders, there are those that believe that a bicycle with pedals is too difficult for most very young children and that training wheels may encourage the rider to learn some behaviors which later must be unlearned.

There are many different types of scooters. The type of scooter that is the primary focus of the preferred embodiment is what is sometimes referred to as a kick scooter or a push scooter. This type of scooter is a small platform with two or more wheels that is propelled by a rider pushing off the ground. The most common scooters have two hard small wheels, are made primarily of aluminum and for children, and fold for convenience. Some kick scooters have 3 or 4 wheels, or are made of plastic, or are large, or do not fold.

In comparing a scooter to a bicycle, in general, the following are various observations. Unlike a kick scooter, a standard bicycle has a seat and drive train, which bring more speed, cost, weight and bulk. At the end of a journey a folding scooter may be more easily folded and carried indoors than a folding bicycle or even a portable bicycle. Even a non folding scooter is easier to bring into crowded places, since it lacks pedals which jut out. Thus a bicycle has advantages on longer journeys and open spaces, while a kick scooter on shorter and more crowded ones. Kickers seldom have a luggage rack, so the rider usually carries any cargo by backpack or other bag.

At minimal speeds a bicycle is difficult to control while pedaling, which is why bicyclers sometimes kick their way through dense traffic or other conditions where they cannot take advantage of the speed of their machine. Thanks to the superior low-speed stability of a kicker, it is allowed on many footpaths where riding a bicycle is forbidden.

Since the feet are lower to the ground, it is easier to step on and off a scooter than even a step-through frame bicycle, hence the rider can alternate walking and pushing as energy and route dictate. Large wheel scooters may afford a more effective cross training workout than standard bicycles as the whole body is engaged in the effort of kicking. Pushing or kicking a large wheel scooter places less stress on the knee joint than does pedaling a bicycle.

Both vehicles offer amusement and skill development for young children. The realm of balance bicycle is not, strictly, limited to very young children as there may be developmentally challenged older children at a similar level of skill. However, the main focus is on very young children eighteen to sixty months. The type of vehicles, design considerations, and costs are particularly important and different when considering combining a standard pedal bike with a “normal” sized scooter. For example, young children are notoriously well-known to quickly outgrow their toys and clothing. Motivations to combine skill developing toys, when possible, helps to ensure that the child has access to a wider ranger of skill development tools at a lower cost. It is sometimes the case that a young child will not be provided with either a bike or a scooter until “older” and then they may receive only one of the two devices because of cost considerations.

What is needed is an efficient multimodal convertible balance bicycle and scooter particularly adapted for very young children.

### BRIEF SUMMARY OF THE INVENTION

Disclosed is a convertible multimodal vehicle (e.g., balance bike and kick scooter) particularly suited for small children. A representative vehicle convertible between a balance bicycle and a scooter, the vehicle includes (a) a platform for supporting a rider standing on the platform, the platform having at least one standing portion generally close to and parallel to a surface supporting a movement of the vehicle over the surface; (b) a steering arrangement coupled to a forward portion of the platform, the steering arrangement enabling the rider to control a direction of the movement of the vehicle; (c) a motive system, coupled to the platform, consisting of a pair of wheels, a forward wheel coupled to the steering arrangement and a rear wheel coupled to a rear portion of the platform; and (d) a seating arrangement, removably coupled to the platform, for supporting the rider when seated on the seating arrangement, the seating arrangement providing a scooter-mode when removed and a balance-bicycle mode when installed; wherein the rider propels the movement in both modes using at least one foot to periodically contact the surface and wherein the vehicle does not include an alternate propulsion system selected from the group consisting of one or more of a motor, a pedal-system, a towing system, and combinations thereof.

### BRIEF DESCRIPTION OF THE DRAWINGS

FIG. 1 is a side view of a first preferred embodiment for a convertible multimodal vehicle in a scooter mode;

FIG. 2 is a side view of the first preferred embodiment for the convertible multimodal vehicle in a balance bike mode;

FIG. 3 is a side view of a second preferred embodiment for a convertible multimodal vehicle in a scooter mode;

FIG. 4 is a side view of the second preferred embodiment for the convertible multimodal vehicle in a balance bike mode;

FIG. 5 through FIG. 12 are detailed views of the first embodiment shown in FIG. 1 and FIG. 2, with FIG. 5 through FIG. 8 including details for the bike mode and FIG. 9 through FIG. 12 including details for the scooter mode.

FIG. 5 being an overview of a top plan view, a front elevation and a side elevation;

FIG. 6 being a detail of the side elevation;

FIG. 7 being a detail of the front elevation;

FIG. 8 being a detail of the top plan view;

FIG. 9 being an overview of a top plan view, a front elevation and a side elevation;

FIG. 10 being a detail of the side elevation;

FIG. 11 being a detail of the front elevation; and

FIG. 12 being a detail of the top plan view.

### DETAILED DESCRIPTION OF THE INVENTION

The present invention relates to apparatus, systems, and methods that provide creative solutions for a multimode amusement vehicle that includes various modes for different developmental levels and enables activities appropriate for a wide-range of maturity, and that safely helps young children through the maturing process as they gain skill and confidence. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

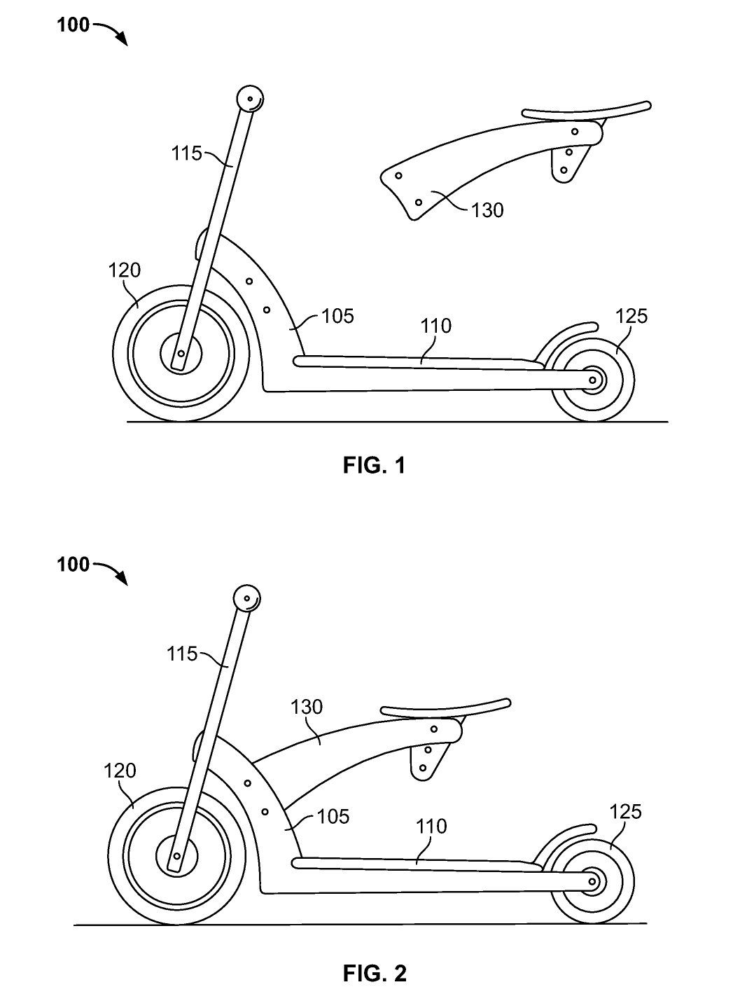

FIG. 1 is a side view of a first preferred embodiment for a convertible multimodal vehicle 100 in a scooter mode. FIG. 2 is a side view of convertible multimodal vehicle 100 in a balance bike mode. Vehicle 100 includes a platform 105 having a standing portion 110, a steering mechanism 115 coupled to a forward portion of platform 105, a forward wheel 120 coupled to steering mechanism 115 and a rearward wheel 125 coupled to a rear portion of platform 105. A removable seat 130 is repeatedly and easily connected to, and removed from, platform 105.

Vehicle 100 is designed for use by very young children and is small, lightweight, and strong enough to support the child in standing or sitting modes. Standing portion 110 is low to the ground to enable a rider standing on standing portion 110 to propel vehicle 100 over a riding surface by pushing or kicking the riding surface. The rider controls the direction of motion using steering mechanism 115.

When removable seat 130 is removed, vehicle 100 is in scooter mode and the rider stands on standing portion 110. When removable seat 130 is installed, vehicle 100 is in balance bike mode and the rider sits on removable seat 130. Seat 130 is arranged (and further adjustable) so that the seated rider is also able to propel vehicle 100 over the riding surface by pushing or kicking the riding surface. The seated rider also controls the direction of motion using steering mechanism 115.

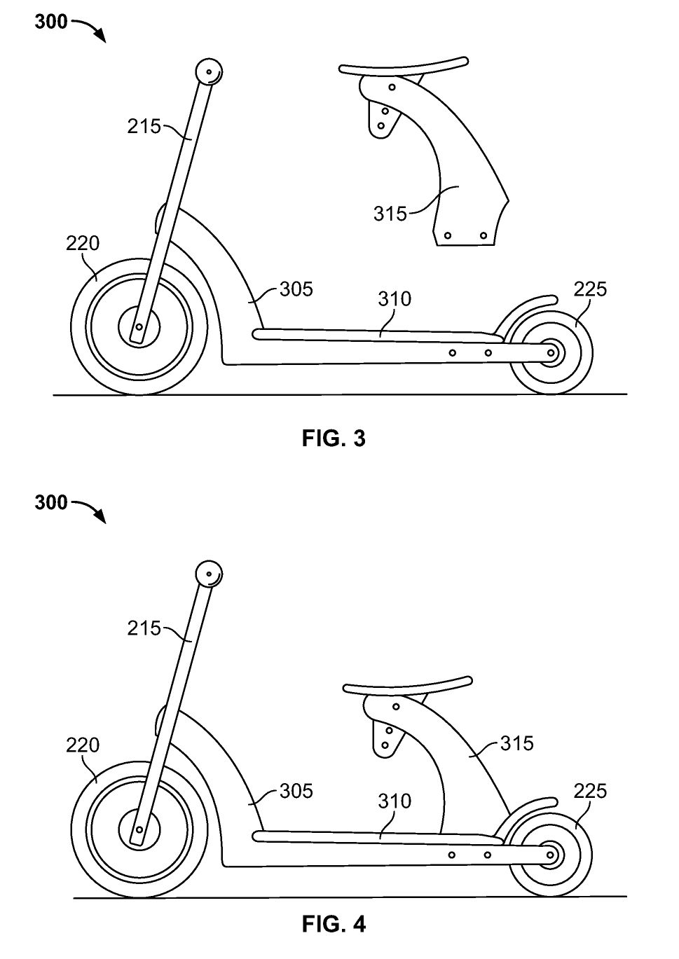

FIG. 3 is a side view of a second preferred embodiment for a convertible multimodal vehicle 300 in a scooter mode. FIG. 4 is a side view of convertible multimodal vehicle 300 in a balance bike mode. Vehicle 300 includes a platform 305 having a standing portion 310, steering mechanism 115 coupled to a forward portion of platform 305, forward wheel 120 coupled to steering mechanism 115 and rearward wheel 125 coupled to a rear portion of platform 305. A removable seat 315 is repeatedly and easily connected to, and removed from, platform 305.

Vehicle 100 and Vehicle 300 are similar in construction and operation. One difference is that vehicle 100 and vehicle 300 have different arrangements for coupling the removable seat to the platform. In vehicle 100, seat 130 is coupled to a forward portion of platform 105 while in vehicle 300, seat 315 is coupled to a rearward portion of platform 305.

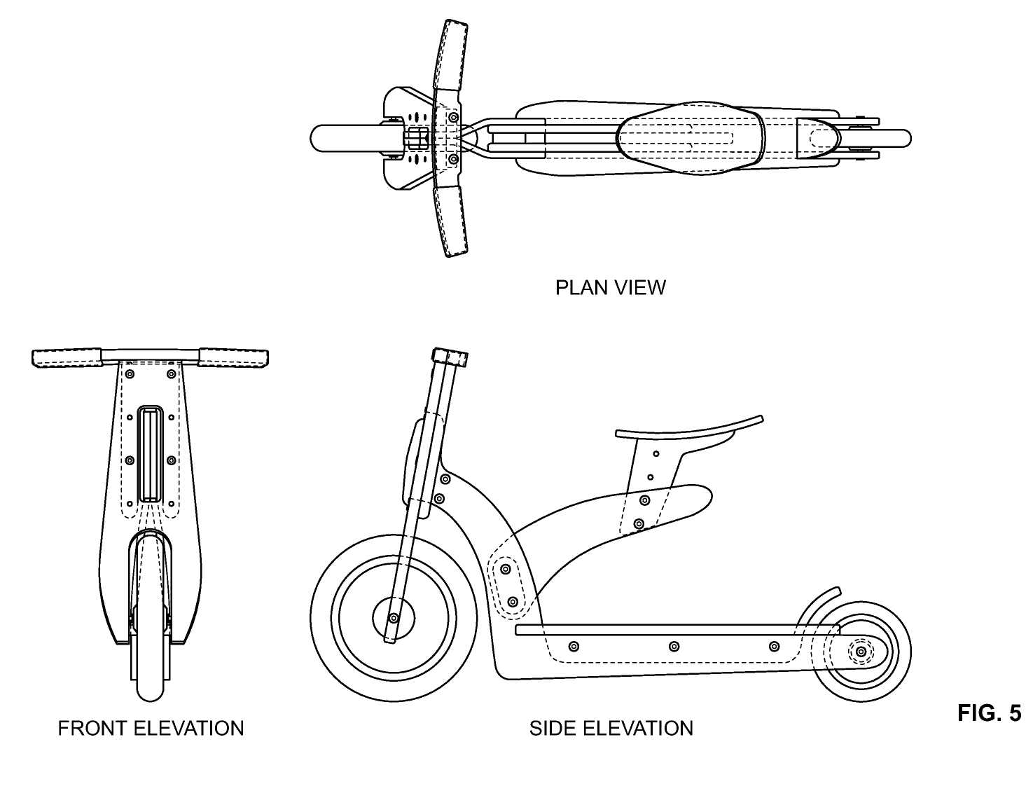

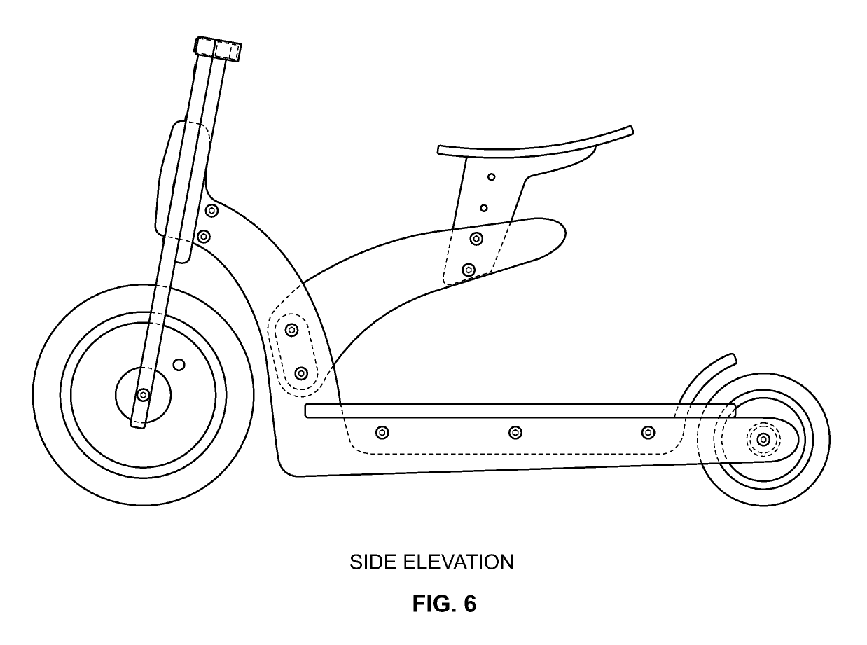

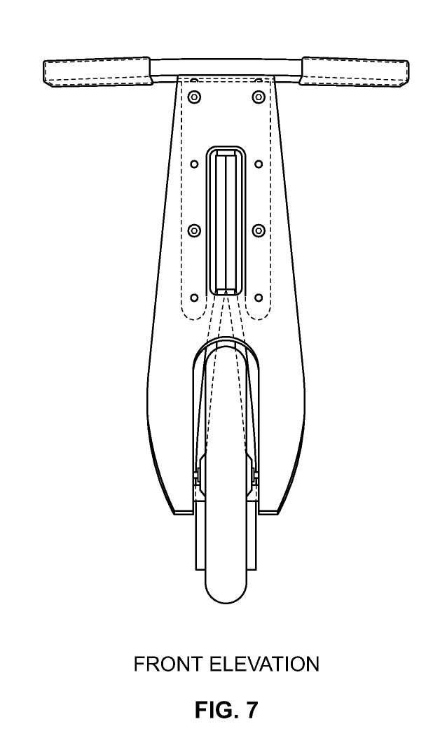

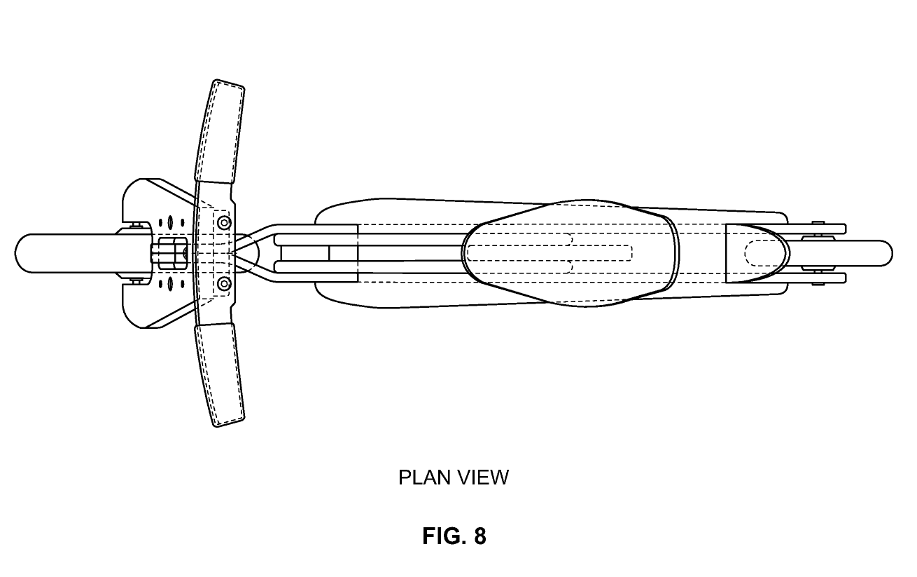

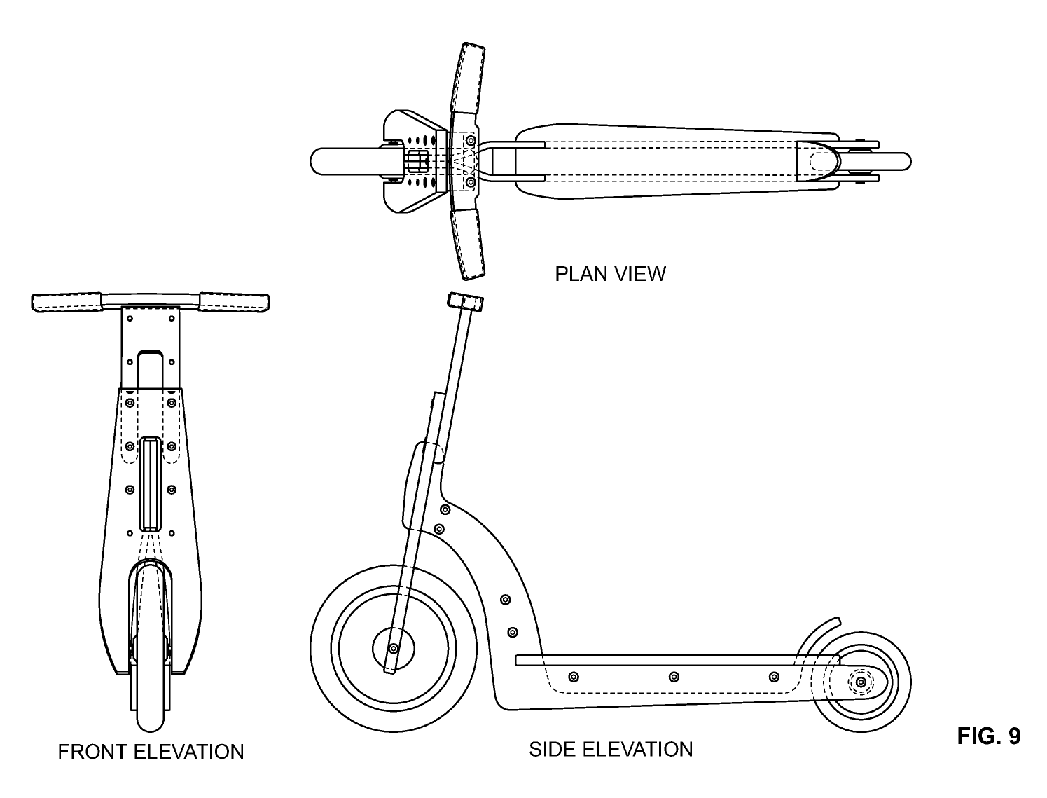

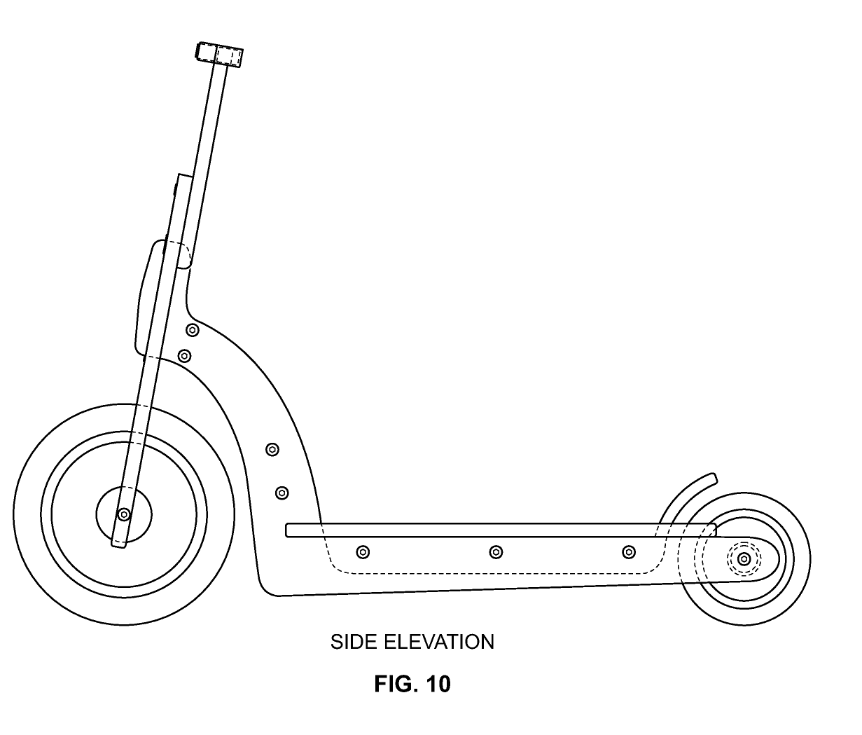

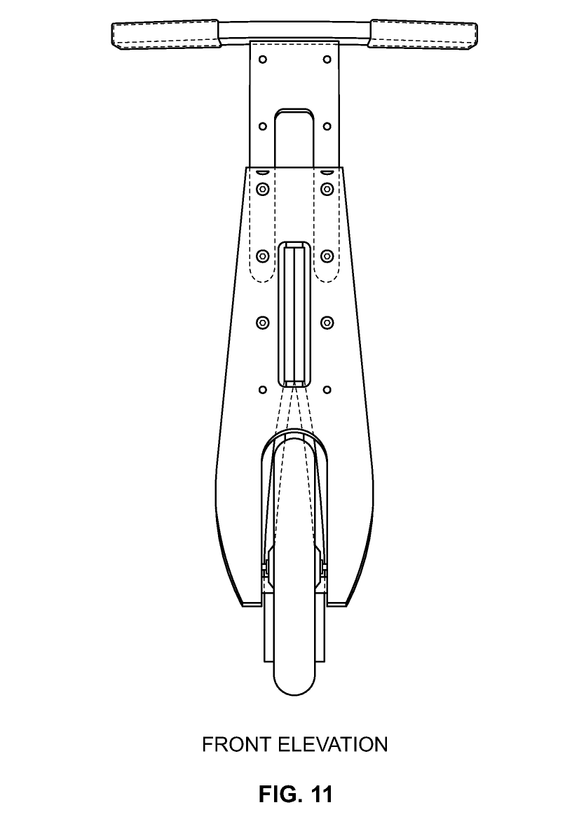

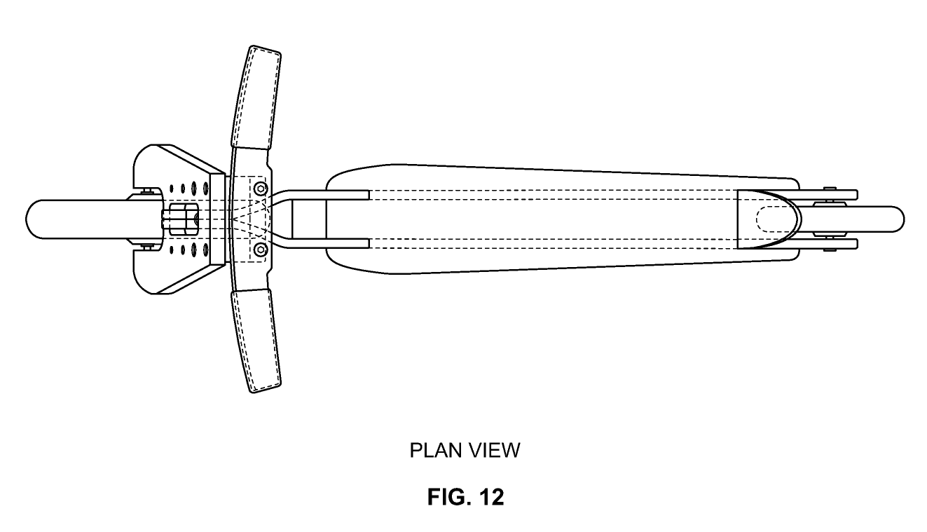

FIG. 5 through FIG. 12 are detailed views of the first embodiment shown in FIG. 1 and FIG. 2, with FIG. 5 through FIG. 8 including details for the bike mode and FIG. 9 through FIG. 12 including details for the scooter mode. FIG. 5 being an overview of a top plan view, a front elevation and a side elevation. FIG. 6 being a detail of the side elevation. FIG. 7 being a detail of the front elevation. FIG. 8 being a detail of the top plan view. FIG. 9 being an overview of a top plan view, a front elevation and a side elevation. FIG. 10 being a detail of the side elevation. FIG. 11 being a detail of the front elevation. FIG. 12 being a detail of the top plan view.

In the embodiments shown above, the frame and components may be made of metal or other suitable structural components. Part of the motivation of the preferred embodiment is provision of the multimodal vehicle at low cost. This is possible, in part, because the structural support elements are adapted for very young children who are relatively small and light-weight. Materials otherwise unsuitable for bicycles for older children and adults may be useful for the present invention.

Included in the embodiments is a braking element. This is shown in the preferred embodiment as the movable rear fender that may be foot-operated to contact the rear wheel. This would slow/stop the vehicle. Other braking is possible, such as hand-operated brakes mounted on the steering/handlebar that control a braking system used in cooperation with one of the wheels (e.g., the forward wheel).

The present invention relates to a multimodal vehicle for young children, and as noted above, part of the motivation of the present invention in combining a kick scooter with a balance bicycle is due to decreasing costs associated with providing a vehicle particularly adapted to young children who grow quickly. Embodiments of the present may include adjustable handlebar height (useful in both bicycle and scooter modes) and height seating (for bicycle mode). As the rider height differs, the handlebars/seat height may accommodate these riders. This has the ability to further increase the temporal usefulness of the product.

In the description herein, numerous specific details are provided, such as examples of components and/or methods, to provide a thorough understanding of embodiments of the present invention. One skilled in the relevant art will recognize, however, that an embodiment of the invention may be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

It will also be appreciated that one or more of the elements depicted in the drawings/figures may also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims. Thus, the scope of the invention is to be determined solely by the appended claims.

What is claimed as new and desired to be protected by Letters Patent of the United States is:

1. A vehicle convertible between a balance bicycle and a scooter, the vehicle comprising:
(a) a platform for supporting a rider standing on said platform, said platform having at least one standing portion generally close to and parallel to a surface supporting a movement of the vehicle over said surface;
(b) a steering arrangement coupled to a forward portion of said platform, said steering arrangement enabling the rider to control a direction of said movement of the vehicle;
(c) a motive system, coupled to said platform, consisting of a pair of wheels, a forward wheel coupled to said steering arrangement and a rear wheel coupled to a rear portion of said platform; and
(d) a seating arrangement, removably coupled to said platform, for supporting said rider when seated on said seating arrangement, said seating arrangement providing a scooter-mode when removed and a balance-bicycle mode when installed;
wherein said rider propels said movement in both modes using at least one foot to periodically contact said surface and wherein the vehicle does not include an alternate propulsion system selected from the group consisting of one or more of a motor, a pedal-system, a towing system, and combinations thereof.

2. A method of operating a vehicle convertible between a balance bicycle and a scooter, the method comprising:
(a) propelling the vehicle over a surface using a rider, the vehicle configured as the scooter and the rider standing on a platform of the vehicle to use at least one foot of the rider to periodically contact said surface;
(b) converting the vehicle to the balance bicycle by installing a removable seating arrangement;
(c) propelling the vehicle over the surface using said rider, the rider seated upon the seating arrangement to use at least one foot of the rider to periodically contact said surface;
wherein the vehicle does not include an alternate propulsion system selected from the group consisting of one or more of a motor, a pedal-system, a towing system, and combinations thereof.
